(19) United States
(12) Patent Application Publication
(10) Pub. No.: US 2013/0046918 A1
(43) Pub. Date: Feb. 21, 2013

(54) METHOD WRITING META DATA WITH REDUCED FREQUENCY

(71) Applicant: JUNG BEEN IM, ANYANG-SI (KR)

(72) Inventor: JUNG BEEN IM, ANYANG-SI (KR)

(73) Assignee: SAMSUNG ELECTRONICS CO., LTD., SUWON-SI (KR)

(21) Appl. No.: 13/492,968

(22) Filed: Jun. 11, 2012

(30) Foreign Application Priority Data
Aug. 18, 2011 (KR) 1020110082176

(51) Int. Cl. G06F 12/00; G06F 12/02

(52) U.S. Cl. 711/103; 711/154; 711/104; 711/E12.001; 711/E12.008

(57) ABSTRACT

A method of writing meta data in a semiconductor storage device in relation to a maximum number of written meta data pages N. The method stores write data in a buffer and loads meta data in a meta memory, writes the write data to the storage medium and updates the meta data. The updated meta data is stored upon determining a number of written meta data pages in an updated meta data region, and only exceeding the maximum number of written meta data pages N, a meta data write operation is performed.

### CROSS-REFERENCE TO RELATED APPLICATIONS

This U.S. non-provisional patent application claims priority under 35 U.S.C. §119 to Korean Patent Application No. 10-2011-0082176, filed Aug. 18, 2011, the subject matter of which is hereby incorporated by reference.

### BACKGROUND OF THE INVENTION

The present inventive concept relates to data storage devices, and more particularly, to a method of writing meta data that reduces or minimizes meta data writing frequency.

Among other types of semiconductor storage devices, flash memory devices have been widely adopted in digital data and portable information systems such as computers, PDAs, digital cameras, cellular phones, MP3 players, solid state drives/disk (SSDs), memory cards, etc. One feature that makes the use of flash memory attractive in such systems is its ability to bulk erase stored data (e.g., on a memory block by memory block basis).

Various types of memory have historically been used to store different types of data using different techniques. So called “meta data” is one type of data that is commonly stored in relation to memory systems and memory devices. Meta data is multiple types of data that are essentially used to manage the information (or “payload data”) stored in a semiconductor storage device, like flash memory.

In certain conventional applications, it is desirable to store meta data in a fast access type of memory (e.g., Random Access Memory or RAM) that will be referred to as “meta memory”. Unfortunately, expanding memory system management requirements sometimes makes it impossible to store all of the system's meta data in the meta memory, due to practical limitations on the size of the meta memory. As a result, some portion of the meta data must be stored in memory other than the meta memory (e.g., flash memory also used to store payload data) while other portions of the meta data is loaded into the meta memory. Hence, the system's meta data is functionally divided into multiple portions that must be variously loaded and re-loaded into meta memory from the flash memory on an as-needed basis.

This loading and unloading of meta data presents a number of problems to memory systems designers. For example, some portion of meta data stored in flash memory might require a change due to some event (e.g., execution of a merge operation or a write operation, a file re-definition by a related file system, etc.). When such an event happens, the implicated meta data must be updated by a “meta data write operation” (i.e., a write operation directed to portions of memory storing meta data and designed to change the contents of the stored meta data).

Naturally, the execution of a meta data write operation precludes the simultaneous use of memory system resources in the execution of other operations. Indeed, overly frequent meta data write operation will degrade write performance, data access speed, and data throughput characteristics of the constituent storage device, and may also reduce the useful lifespan of the flash memory cells.

### SUMMARY OF THE INVENTION

Embodiments of the inventive concept provide a method of writing meta data in a semiconductor storage device including a controller having a buffer, a portion of the buffer serving as a meta memory, and nonvolatile storage medium, the method comprising; using the controller to determine a maximum number of written meta data pages N, where N is natural number, receiving write data and corresponding meta data in the controller, storing the write data in the buffer, and loading the meta data in the meta memory, writing the write data to the storage medium and updating the meta data in the meta memory as updated meta data, writing the updated meta data to an updated meta data region of the buffer and determining a number of written meta data pages in the updated meta data region, and only upon determining that the number of written meta data pages exceeds the maximum number of written meta data pages N, performing a meta data write operation writing the updated meta data stored in the updated meta data region to the storage medium.

Embodiments of the inventive concept also provide a method of writing meta data comprising; setting the number of data page writings depending on a time difference between a read operation of flash memory and a write operation of flash memory, and then without writing changed meta data in a flash memory whenever changes occur in the meta data, the changed meta data is restored to the latest meta data using a logical address stored in a page spare area of the data page and the changed meta data is written in the flash memory only when the number of data page writings reaches the number of time that is set.

Embodiments of the inventive concept also provide a method executing a first write operation and a second write operation requested by a host to a semiconductor storage device including a controller having a volatile memory and nonvolatile storage medium, the method comprising; receiving in the controller first write data and first meta data related to the first write operation, and then receiving second write data and second meta data related to the second write operation, writing the first write data to the storage medium, updating the first meta data in response to writing the first write data to generate updated first meta data, and temporarily storing the updated first meta data in the volatile memory, and thereafter, writing the second write data to the storage medium, updating the second meta data in response to writing the second write data to generate updated second meta data, and temporarily storing the updated second meta data in the volatile memory, and thereafter, writing the updated first meta data and the updated second meta data from the volatile memory to the storage medium, only upon determining that a combination of the updated first meta data and updated second meta data stored in the volatile memory exceeds a control value.

### BRIEF DESCRIPTION OF THE DRAWINGS

Certain embodiments of the inventive concept will now be described with reference to the accompanying drawings.

FIG. 1 is a block diagram of semiconductor storage device in accordance with some embodiments of the inventive concept.

FIG. 2 is a block diagram further illustrating in one embodiment the controller of FIG. 1.

FIG. 3 is a block diagram further illustrating in one embodiment the storage device of FIG. 1.

FIG. 4 is a flow chart summarizing one possible method of controlling the writing of meta data in accordance with some embodiments of the inventive concept.

FIG. 5 is a somewhat more detailed flow chart summarizing one possible method of writing meta data in accordance with some embodiments of the inventive concept.

FIG. 6 is a conceptual diagram illustrating one example of a memory page that may be used in the storage device of FIG. 3.

FIG. 7 includes conceptual drawings contrasting different methods of meta data writing drawn in relation to some embodiments of the inventive concept.

FIG. 8 is a graph showing exemplary performance in random writing in accordance with some embodiments of the inventive concept.

FIG. 9 is a block diagram illustrating one application example for certain embodiments of the inventive concept applied to a data processing device.

FIG. 10 is a block diagram illustrating another application example for certain embodiments of the inventive concept applied to a fusion memory system.

FIG. 11 is a block diagram illustrating another application example for certain embodiments of the inventive concept applied to a computational system.

### DETAILED DESCRIPTION

Embodiments of inventive concepts now be described in some additional detail with reference to the accompanying drawings. The embodiments of the inventive concept may, however, be embodied in different forms and should not be constructed as being limited to only the illustrated embodiments. Rather, these embodiments are provided so that this disclosure will be thorough and complete, and will fully convey the scope of the inventive concept to those skilled in the art. Throughout the written description and drawings, like numbers refer and labels are used to denote like or similar elements and features.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

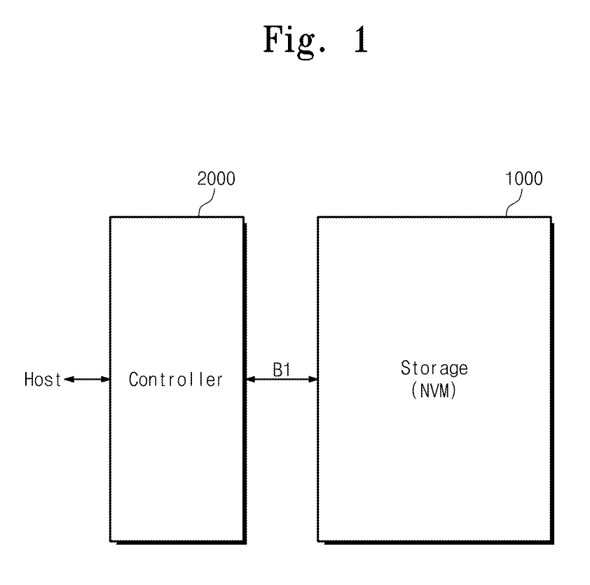

FIG. 1 is a block diagram of semiconductor storage device in accordance with certain embodiments of the inventive concept.

Referring to FIG. 1, the semiconductor storage device comprises storage medium 1000, such as an array of nonvolatile memory cells, and a controller 2000. The storage medium 1000 may be used to store different types of data, such as a payload data (e.g., text file data, graphic data, video and music files, etc.) software core, etc. The storage medium 1000 may be embodied by various nonvolatile memories such as a NAND flash memory, a NOR flash memory, a phase change memory device PRAM, a ferroelectric random access memory FRAM, a magnetic random access memory MRAM and/or the like.

The controller 2000 controls execution of operations directed to the storage medium 1000 in response to requests provided by a host (not shown). The controller 2000 may compress externally provided data and control the writing (or programming) of the resulting compressed data in the storage medium 1000. The use of one or more conventionally understood data compression methods further allows the storage medium 1000 to effectively store very large quantities of data at low cost. The use of one or more data compression methods also reduces the amount of data being transferred via bus B1 between the storage medium 1000 and the controller 2000.

In certain embodiments the semiconductor storage device may include a relatively small meta memory disposed (e.g.,) in the controller 2000. Accordingly, only a “requested meta data portion” among the whole of the meta data that is otherwise stored in the storage medium 1000, is loaded in the meta memory of the controller 2000. That is, due to capacity constraints of the meta memory, a requested meta data portions related to a “current operation” is loaded to the meta memory to overwrite a “previous meta data portion” related to a previously executed operation (hereafter “previous operation”).

The meta data may include at least one of a file data name, a directory name related to the file data, an access right to the file data, and time information related to file data. The meta data may also include state information indicating usable block region(s) and usable page region(s) in the storage medium 1000.

If the previous meta data portion stored in the meta memory before execution of the current operation (and corresponding loading of the requested meta data portion) has been changed during the previous operation, the copy of the previous meta data portion stored in the storage medium 1000 must be commensurately updated. This update of the previous meta data portion requires execution of a meta data write operation. However, as noted above, too frequent execution of meta write operations by a semiconductor storage device impairs performance and may also reduce the useful lifespan of memory cells in the semiconductor storage device. Embodiments of the inventive concept effectively reduce or minimize the frequency of meta data write operations.

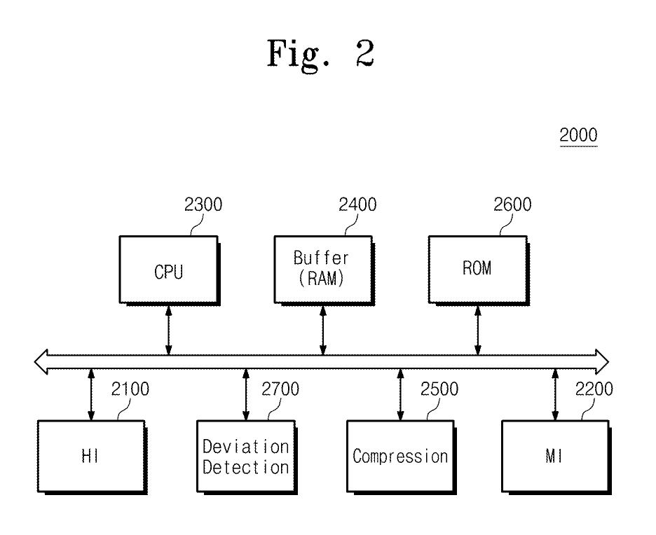

FIG. 2 is a block diagram further illustrating in one embodiment the controller 2000 of FIG. 1.

Referring to FIG. 2, the controller 2000 comprises a first (or host) interface 2100 (HI), a second (or memory) interface 2200 (MI), a central processing unit (CPU) 2300, a buffer 2400 (e.g., a RAM), a compression block 2500, a deviation detection block 2700 and a Read Only Memory (ROM) 2600.

The first interface (HI) 2100 is configured to interface the controller 2000 with one or more external host(s). The second interface (MI) 2200 is configured to interface with the storage medium 1000 of FIG. 1. The CPU 2300 is configured to control the overall operation of the controller 2000. For instance, the CPU 2300 may be configured to operate according to firmware including a flash translation layer (FTL). This firm ware may include certain software components stored in the ROM 2600. As is conventionally understood, the FTL may generally be used to manage mapping information between logical data addresses provided by a host and corresponding physical data addresses of the storage medium 1000. The FTL may also be used to manage wear-leveling of the memory cells of the storage medium 1000, bad blocks defined within the storage medium 1000, and perform data saving routines during unexpected interruptions in the power supply.

The buffer 2400 may be used to temporally store data received from a host via the first interface 2100, to temporally store data retrieved from the storage medium 1000 via the second interface 2200. The buffer 2400 may also be used as the meta memory.

The compression block 2500 may be configured to compress data of the buffer 2400 under the control of the CPU 2300 or the FTL as executed by the CPU 2300. The compressed data may then be stored in the storage medium 1000 via the second interface 2200. The compression block 2500 may also be configured to decompress data retrieved from the storage medium 1000 under the control of the CPU 2300 or the FTL as executed by the CPU 2300. One or more compression function(s) may be performed by the compression block 2500 as selectively applied.

For example, input data may be stored in the storage medium 1000 through the buffer 2400 without compression, or a given data compression function may be applied according to type of input data. In the case of high volume multimedia data (one common type of payload data) data compression is usually performed. Other types of low volume input data do not warrant compression in view of the time and power required to obtain it. The application of compression to input data by the compression block 2500 may be controlled using hardware methods or software methods. In certain embodiments or operating modes, input data may be directly stored in the storage medium 1000 via the first and second interfaces 2100 and 2200 without passing through the buffer 2400.

The controller 2000 may be used to set (or define) a “maximum number of written meta data pages” in view of execution time difference(s) between read operations directed to (e.g.,) flash memory cells of the storage medium 1000 and similar write operations in order to reduce or minimize the frequency of meta data write operations. The control value (the maximum number of written data pages) may be used to effectively decrease the number of meta data write operations that must be performed in the storage medium 1000. That is, when a previous meta data portion has been changed—conventionally necessitating a corresponding meta data write operation—the controller 2000 of certain embodiments of the inventive concept will not immediately perform a meta data write operation directed to the copy of the previous meta data portion stored in the storage medium 1000. Rather, the CPU 2300 will cause each updated previous meta data portion to be temporarily stored in the RAM of buffer 2400 until such time as the maximum number of written meta data pages has been reached. A particular “updated meta data region” of buffer 2400 may be used to store 1 to N updated previous meta data portions, where N is a natural number. Logical address(es) corresponding to the 1 to N updated previous meta data portions may be used to reference the particular region of the buffer 2400. Only after the maximum number of written meta data pages has been reached or exceeded will the controller 2000 then perform a single (or “compound”) meta data write operation to the storage medium 1000 for all of the updated meta data portions stored in the updated meta data region of the buffer 2400.

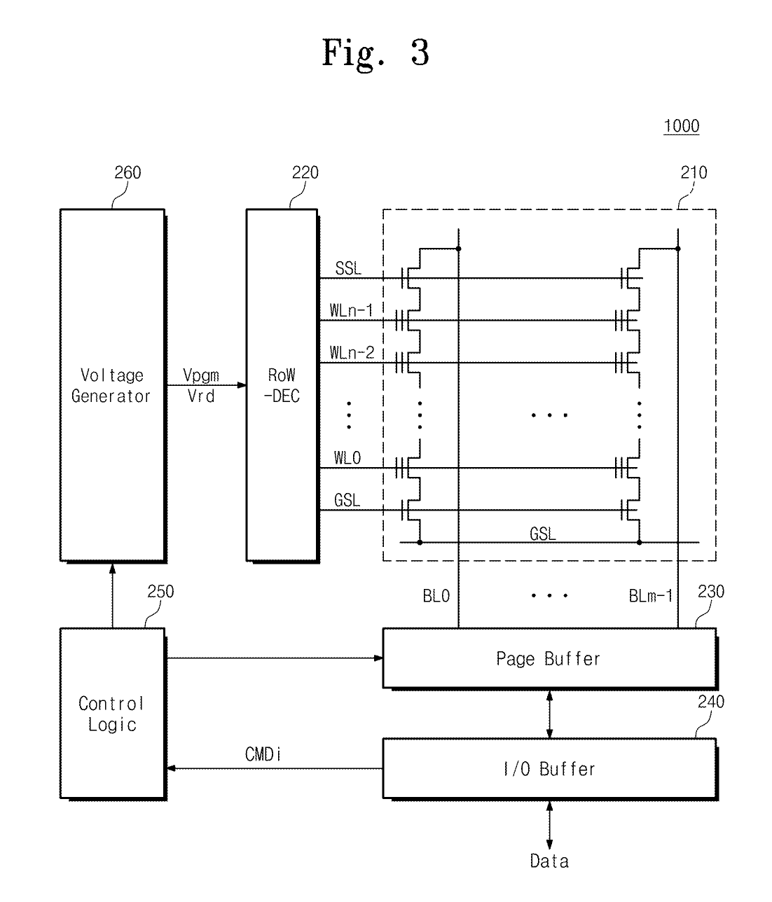

FIG. 3 is a block diagram illustrating one possible embodiment for the storage medium 1000 of FIG. 1.

Referring to FIG. 3, the storage medium 1000 is assumed to be embodied by a flash memory. The flash memory includes a memory cell array 210, a row decoder 220, a page buffer 230, an input/output buffer 240, a control logic 250 and a voltage generator 260.

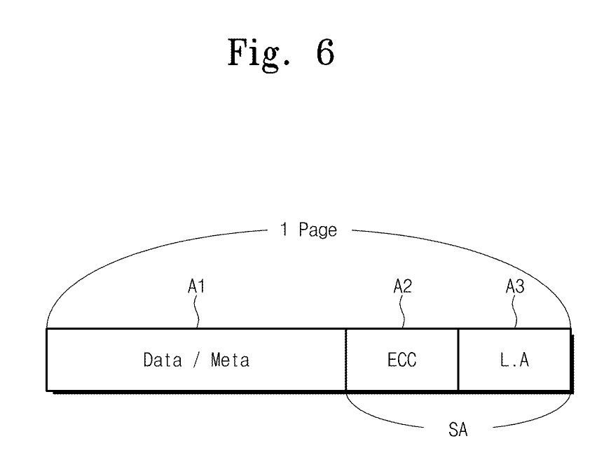

The memory cell array 210 includes a plurality of memory cells connected to a bit line and a word line. The memory cell array 210 includes a main area in which a message field of write (program) data is stored and a spare area in which control information of the message field is stored. Write data may be stored in a plurality of pages in memory cells connected to one word line. In particular, in a memory device including multi level cells, write data may be stored in a plurality of pages in memory cells connected to one word line. When the write data is stored, the write data may each be randomized to be stored in the main area (A1 of FIG. 6). Meta data corresponding each write data may also randomized to be stored in another portion of the main area.

Of note, randomizing of the write data and meta data may be helpful in preventing deterioration of the write data and meta data relative to memory cells. When one data page is written (programmed), not only the write data but also the meta data may be randomized.

The row decoder 220 selects a word line in response to a row address. The row decoder 220 transfers all sorts of word line voltages (Vgm, Vrd . . . ) provided from the voltage generator 260 to the selected word lines. When a program operation is performed, a program voltage Vpgm of about 15V˜20V and a verification voltage Vfy are transferred to a selected word line and a pass voltage Vpass is transferred to an unselected word line. When a read operation is performed, the row decoder 220 provides a read voltage Vrd provided from the voltage generator 260 to a selected word line and provides a read voltage Vread of about 5V to an unselected word line.

The page buffer 230 operates as a writer driver or a sense amplifier according to an operation mode. For instance, the page buffer 230 operates as an sense amplifier in a read operation mode and operates as a writer driver in a program operation mode. The page buffer 230 may load data of one page unit when a program operation is performed. That is, the page buffer 230 may receives data to be programmed through the input/output buffer 240 to store in an internal latch. When writing (programming) the loaded data, the page buffer 230 provides a ground voltage (e.g., 0V) to a bit line of memory cells being programmed. The page buffer 230 provides a pre-charge voltage (e.g., Vcc) to a bit line of memory cells being program-inhibited.

The input/output buffer 240 temporally stores an address or writing data received through an input/output pin. The input/output buffer 240 transfers a stored address to an address buffer (not shown), program data to the page buffer 230 and a command to a command register (not shown). When a read operation is performed, read data provided from the page buffer 230 is output to the outside through the input/output buffer 240.

When a program operation is performed, the control logic 250 receives a command CMDi from the controller 2000 through the input/output buffer 240 and controls the page buffer 230 and the voltage generator 260 so that program data is written in a selected memory cell. The control logic 250 controls the page buffer 230 and the voltage generator 260 so that data of a selected cell area is read in response to a command of the controller 2000.

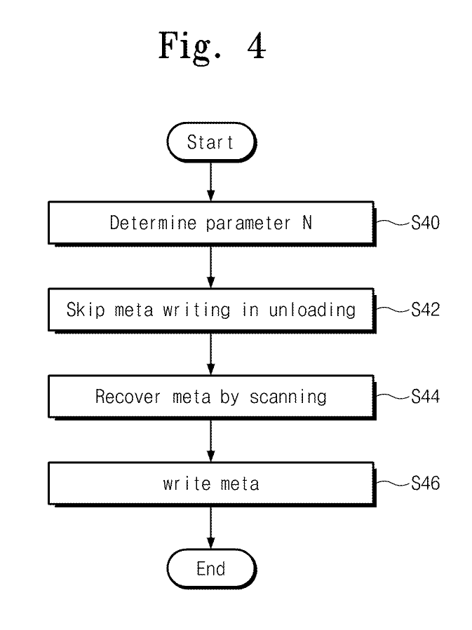

FIG. 4 is a flow chart summarizing a method of writing meta data in accordance with some embodiments of the inventive concept.

First, the controller 2000 of FIG. 1 selects a control value (or parameter) “N” defining the maximum number of written meta data pages. This control value essentially defines a degree of postponement that may occur before the controller 2000 performs a meta write operation to the storage medium 1000 (S40).

Each time a requested meta data portion is loaded to the buffer 2400 of FIG. 2, for example, a previous meta data portion must be unloaded. If the previous meta data portion being unloaded has been changed during the previous operation, such changes must be accurately reflected in the meta data copy stored in the storage medium 1000. Rather than immediately performing a meta data write operation to update the previous meta data portion, however, a version of the updated previous meta data portion is merely stored in the updated meta data region of the buffer 2400.

As a number of pages associated with the updated previous meta data portions (e.g., 1 to K, where K is less than N) temporality stored in the buffer 2400 increases, the available storage space in the buffer 2400 shrinks. Yet so long as K remains below N, the controller 2000 may skip execution of a meta data written operation upon each previous meta data portion unloading (S42). In this manner, embodiments of the inventive concept dramatically reduce the frequency of meta data write operations.

Of course, the ability of the controller 2000 to skip vital meta data update operations is premised upon an assumption that the semiconductor storage device includes a competent data restoration scheme, whereby the integrity of the meta data stored in volatile RAM buffer 2400 may be guaranteed. As a first property, a read time tR of semiconductor storage device is very short as compared with a program time tPROG. For instance, in the case of a flash memory constituted by a single level cell, tR is 25 μs and Tprog is 200 μs. Thus, the tPROG is ten times the tR. That difference may grow greater in a flash memory constituted by a multi level cell.

As a second property, a logical address corresponding to programmed write data exists in a spare area of page. Since an error correction code (ECC) is essentially used in a flash memory because of possibility of occurrence of bit error, an error correction code region A2 (of FIG. 6) is prepared in a spare area of page. A logical address corresponding to physical data written in a corresponding page may be stored in other region of spare area except the error correction code region. The logical address may be used in a debugging operation and a sudden power off restoration operation.

Thus, in certain embodiments of the inventive concept, using the above two properties, improvement in write performance may be had by postponing as much as possible the inevitable meta data write operation. Although meta data is not always written, the latest meta data may be reconstituted using old meta data and a scan result of many pages of logical addresses. By doing so, the frequency of storing meta data may be reduced.

Thus, in the case that tR is 25 μs and tPROG is 200 μs, the control value N may be determined to be 10. Thus in the step S42 described above, the meta data write operation may be skipped until the number of written data pages associated with the updated meta data portions stored in the buffer 2400 reaches 10. This is, of course, a just one specific example drawn to certain assumptions, and may different approaches to the definition of the maximum number of written meta data pages may be used in other embodiments of the inventive concept.

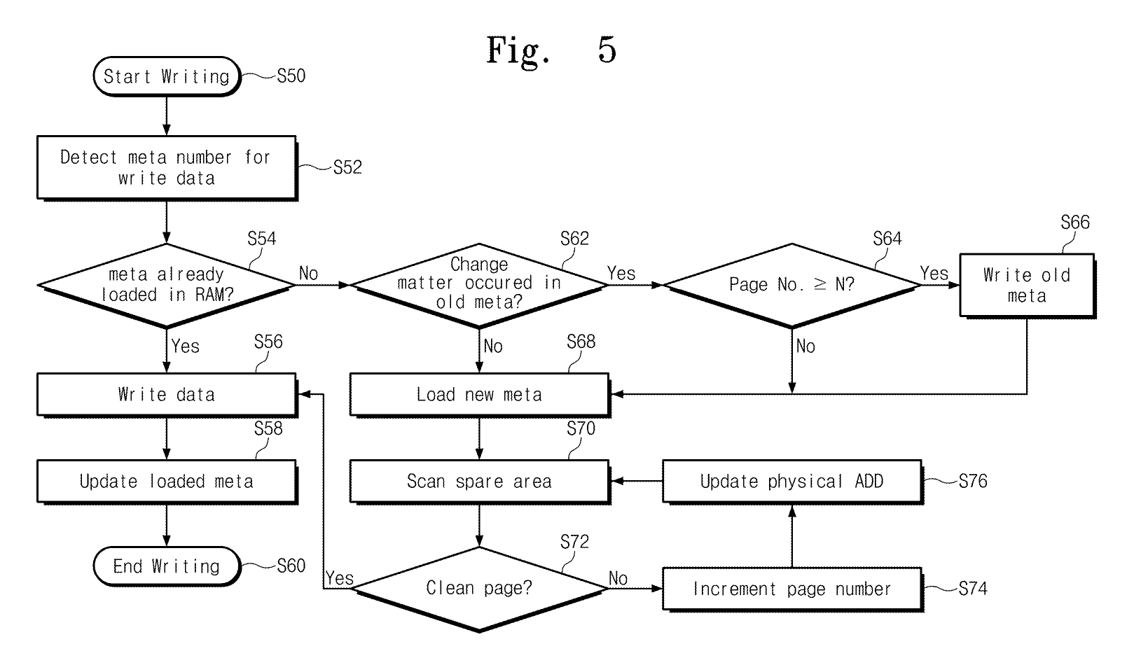

Next, meta data being unloaded by a scanning operation is restored in the RAM 2400 (S44). This operation will be described in some additional detail with reference to FIG. 5.

Finally, meta data may be written (programmed) to the storage medium 1000 (e.g., flash memory) as described in relation to FIG. 3 (S46). This step may be performed when the number of written meta data page reaches N.

FIG. 5 is a flow chart summarizing in some additional detail a method of writing meta data according to certain embodiments of the inventive concept.

In FIG. 5, the sequential execution of steps S52, S54, S56, S58 and S60 represent a general operation during which requested write data is written to flash memory (S56) and loaded meta data is updated in RAM (S58) when meta data is not unloaded. That is, a write operation indicates write data received form a host (S50), whereupon a number of meta data pages associated with the write data is detected (S52). Then, it is determined whether or not meta data corresponding to the write data has been loaded to the RAM of buffer 2400 (S54). For example, if write data having corresponding meta data is received by the controller 2000 and the first meta data is loaded to the buffer 2400 (S54=YES), then the first write data is written to flash memory (S56). After the first write data is written to the flash memory the loaded first meta data is updated in the buffer 2400 (S58), and the write operation is ended (S60).

However, if the meta data is not loaded to the buffer 2400 (S54=NO), it is determined whether or not changes have occurred in “old” meta data (or previous meta data) to be unloaded (S62). If changes have not occurred in the old meta data (S62=NO), the “new” meta data (or current meta data) may be loaded in the buffer 2400 (S68).

However, in certain embodiments of the inventive concept, even if the old meta data has been changed (S62=YES), a meta data write operation need not be immediately performed. That is, embodiments of the inventive concept first determine whether or not a maximum number of written meta data pages N has been reached (S64). As previously noted, the control value N may be determined by comparing a time it takes to program the meta data with a time it takes to scan the spare area of a page. Stated in other terms, a maximum number of meta data pages that can be unloaded without execution of a meta data write operation is N.

Thus, only when the maximum number of written meta data pages has been reached (S64=YES), will a semiconductor storage device according to embodiments of the inventive concept need to perform a write [old] meta data operation (S66) for meta data stored in an updated meta data region of the buffer 2400. So long as the maximum number of written meta data pages remains below N (S64=NO), the meta data written operation (S66) may be skipped and the new meta data may be loaded.

Assuming the meta data write operation has been skipped one or more time, embodiments of the inventive concept may yet ensure meta data integrity by provision of a data restoration function for the latest meta data, as executed for example by steps of S70, S72, S74 and S76 in the flow chart of FIG. 5.

Once new meta data is loaded in the RAM (S68), information stored in a spare area is scanned beginning with a page recorded in the form of a clean page in the new meta data (S70). The clean page indicates a page in which data does not exist anymore. Thus, it is determined whether or not a clean page exists (S72). If it is not the clean page (S72=NO), a page number is incremented (S74) and a logical address stored in a spare area of page and physical address information of the read page are updated in the meta data (S76). That work is repeated until a clean page appears as the page number is incremented.

The clean page check operation is performed to restore the latest meta data. The clean page check operation is an operation to scan a page spare area of data page first recorded in the form of clean page in the meta data and to scan a data page while increasing a page until a real clean page is detected. In the case that a page which is not a real clean page is scanned in the scan operation, a logical address stored in the page spare area and a physical address of scanned page are included in the updated information to be stored.

When a clean page appears (S72=YES), write data may be written in a corresponding page of flash memory (S56) and the loaded meta data is updated in RAM (S58).

From the foregoing it may be seen that a number of meta data written operation conventionally associated with the unloading of old meta data to a flash memory may be skipped and new meta data being newly loaded is restored to the latest meta data in the RAM. As a result, the frequency of meta data write operation may be markedly reduced or minimized.

An operation of scanning data stored in a spare area of page is sequentially performed on a page in flash memory. Thus, when a controller applies a cache read command instead of a page read command to the flash memory, the time required to scan the data is reduced.

If the work of reconstituting meta data is applied to a host read operation, performance deterioration of read operation may occur. Thus, when a host read is frequently requested, the control value N may be reduced accordingly. That is, by reducing N and setting meta data write operations on this additional basis the possibility of read performance deterioration may be further limited.

FIG. 6 is a conceptual diagram illustrating one possible example of storage regions of memory page that may be used in the storage medium of FIG. 3. Referring to FIG. 3, an arbitrary page may be divided into a main area A1 and a spare area SA. In the spare area A1, write data or meta data requested through a host is stored in the main area A1. The spare region SA is called a page spare area and may include an ECC area A2 in which an error correction code and a logical address area A3 in which a logical address is stored.

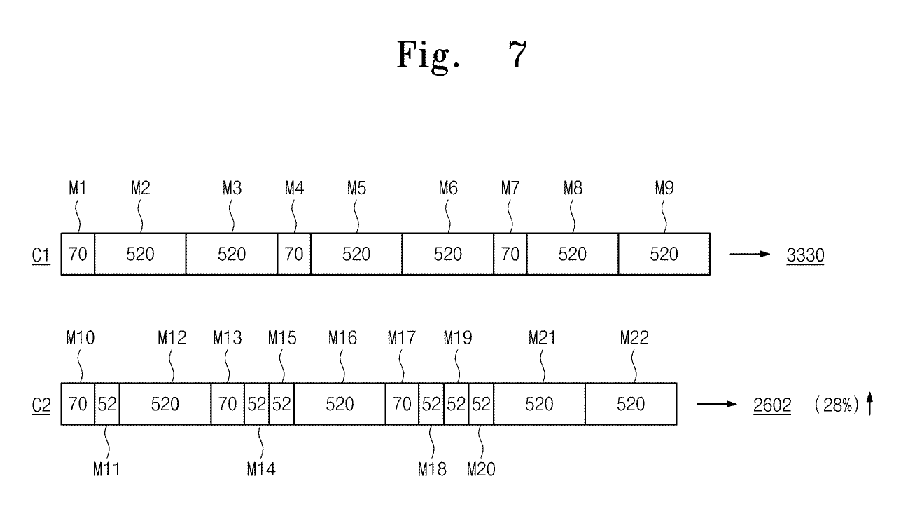

FIG. 7 includes drawings comparing meta data write operations. In FIG. 7, a case is assumed wherein the control value N is set to 3, whereupon the second writing case example C2 shows a 28% improvement over a first writing case example C1. In FIG. 7, units are given in μs. The second writing case C2 is consistent with certain embodiments of the inventive concept where the first writing case C1 is a conventional approach to executing meta data write operations.

Regions M3 and M6 of meta data writing time of C1 are omitted in the writing case of C2 and regions M11, M14, M18, M19 and M20 of data page scan time are added to the writing case of C2. In the even case that a write event relative to the meta data occurs, the latest meta data is written in a region M22 of meta data write time while putting off a write operation of flash memory. In FIG. 7, M1, M4 and M7 of C1 mean a region of loading time (a time loaded in RAM) of meta data and M2, M5 and M8 of C1 mean a region of writing time (a time programmed in a flash memory) of write data. Also, M3, M6 and M9 of C1 mean a region of writing time (a time programmed in a flash memory) of meta data.

In FIG. 7, M10, M13 and M17 of C2 mean a region of loading time (a time loaded in RAM) of meta data and M12, M16 and M21 of C2 mean a region of writing time (a time programmed in a flash memory) of write data. Also, M22 of C2 mean a region of writing time (a time programmed in a flash memory) of meta data. The M10, M13 and M17 are discontinuous to each other and are to keep a case together that same meta data are unloaded in a RAM and are newly loaded.

Since the sum of the regions M11, M14, M15, M18, M19 and M20 of data page scan time is smaller than the sum of the regions M3 and M6 of meta data writing time, in the case of C1, the sum of the times becomes 3330 μs and in the case of C2, the sum of the times becomes 2602 μs. Thus, in the case of some embodiments of the inventive concept that N is set to 3 and a write relative to meta data being unloaded is put off, performance improvement of about 28% is accomplished.

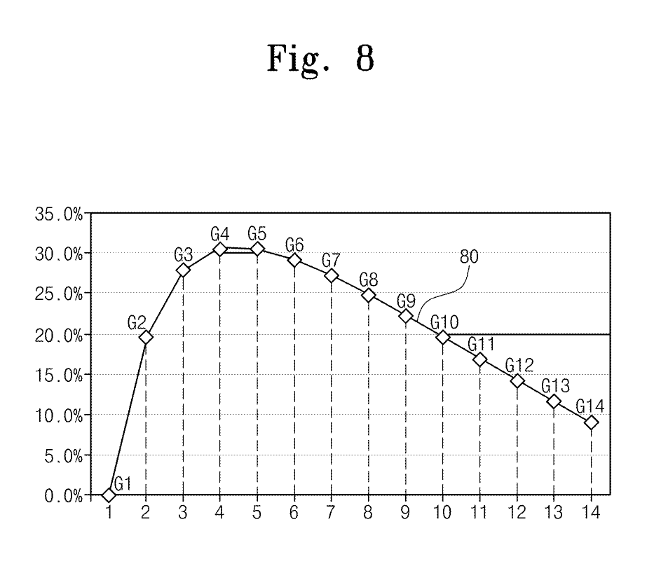

FIG. 8 is a graph showing an example of performance improvement for random writing in accordance with certain embodiments of the inventive concept. In FIG. 8, the horizontal axis represents different values for the control value N, and the vertical axis represents the degree of performance improvement as a function of overall percentage of execution time.

In FIG. 8, a graph 80 shows performance in a 8 KB random write when writing write data and meta data in a memory cell array comprised of single level cells SLC. If assuming that tPROG (SLC) indicating a write (program) time=500 μs, tR (SLC) indicating a read time=50 μs, 8 KB DMA indicating a time to access a data area of page=20 μs and spare DMA indicating a time to access a spare area of page=2 μs, it is given that Meta Load=70 μs, Meta Write=520 μs, Data Write=520 μs and Data Page=52 μs.

Therefore, a graph point G3 in the graph 80 of FIG. 8 shows C2 case of FIG. 7. That is, the graph point G3 indicates a point where a parameter N is 3 and performance improvement is 28%.

In the graph 80 of FIG. 8, when a parameter N is 4 or 5, performance improvement is 30.6% and is greatest.

According to some embodiments of the inventive concept, the frequency of meta data writing is minimized or reduced by writing the latest meta data in a flash memory only when a maximum number of written meta data pages reaches a control value N. Thus, performance of random write is improved and the life of semiconductor storage device is improved.

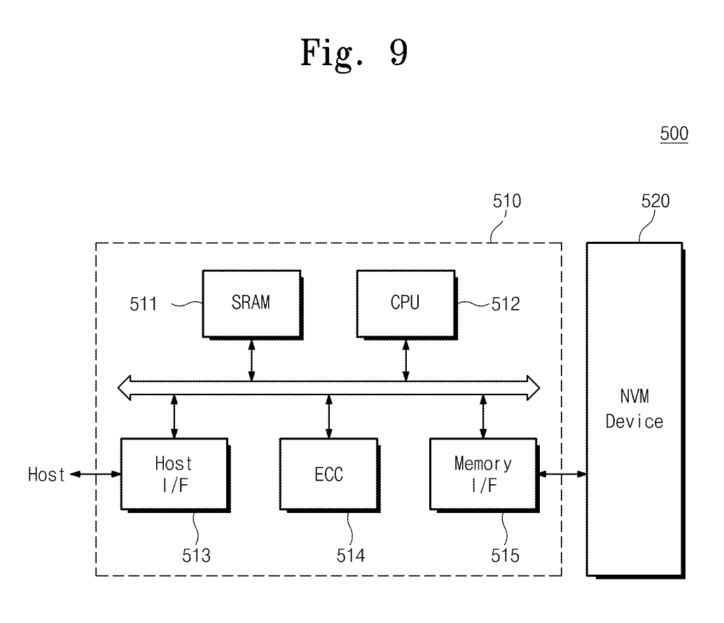

FIG. 9 is a block diagram illustrating an application example of the inventive concept applied to a data processing device. Referring to FIG. 9, a data processing device 500 includes a nonvolatile memory device 520 and a memory controller 510.

The nonvolatile memory device 520 may be embodied by a flash memory described in FIG. 3. The memory controller 510 controls the nonvolatile memory device 520 through a memory interface 515. A memory card or a solid state disk SSD may be provided by a combination of the nonvolatile memory device 520 and the memory controller 510.

A SRAM 511 in the memory controller 510 is used as an operation memory of a central processing unit 512. A host interface 513 is in charge of an interface between the data processing device 500 and a host and may include a data exchange protocol.

An error correction code 514 detects and corrects an error that may be included in data read from the nonvolatile memory device 520.

The memory interface 515 is in charge of an interface between the data processing device 500 and the nonvolatile memory device 520.

The central processing unit 512 performs the whole control operation for data exchange of the memory controller 510. Although not illustrated in the drawing, the memory system 500 in accordance with the inventive concept may further include a ROM (not shown) or a nonvolatile RAM to store code data for interfacing with a host.

The nonvolatile memory device 520 may be provided by a multichip package comprised of a plurality of flash memory chips.

The changed meta data is updated through the SRAM 511 when meta data is unloaded and an operation of programming the meta data in a flash memory is put off until a page write operation occurs N number of times.

Since the data processing device 500 of FIG. 9 does not perform an operation of writing changes in a flash memory whenever the changes occur in the meta data, the frequency of meta writing is minimized or reduced. If the frequency of meta writing is minimized or reduced, random write performance of the data processing device is improved and the life of the data processing device is improved. That is, without writing changed meta data in a flash memory whenever changes occur in the meta data, the data processing device 500 restores the changed meta data to the latest meta data using a logical address stored in a page spare area of the data page and writes the changed meta data in the flash memory only when the number of data page writings reaches the number of times that is set.

Thus, the data processing device 500 may extend the life of the nonvolatile memory device 520 and may be provided as a high reliable storage medium having low probability of error occurrence. The data processing device like a solid state disk SSD may include a flash memory described in FIG. 3. In this case, the memory controller 510 may be configured to communicate with the outside (e.g., a host) through one of various protocols such as μSB, MMC, PCI-E, SATA, PATA, SCSI, ESDI and IDE.

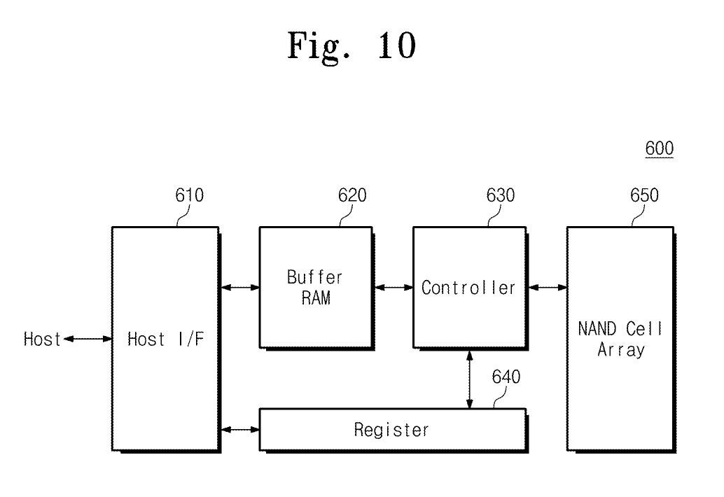

FIG. 10 is a block diagram illustrating another application example of the inventive concept applied to a fusion memory system. One NAND flash memory device 600 may be applied as a fusion memory device or a fusion memory system.

The one NAND flash memory device 600 may include a host interface 610 for exchanging all sorts of information with a device using a different protocol, a buffer RAM 620 to include a code for driving a memory device or to temporally store data, a controller 630 controlling all the states in response to a control signal and a command provided from the outside, a register 640 storing data such as a command, an address and a configuration defining an internal system environment of memory device and a NAND flash cell array 650 including a nonvolatile memory cell and a page buffer.

The one NAND flash memory device 600 performs a writing of write data and meta data in accordance with some embodiments of the inventive concept in response to a write request from a host.

In the case that new meta data is loaded and the meta data loaded before is unloaded in the buffer RAM 620, the changed meta data is updated through the buffer RAM 620 and an operation of programming the meta data in the NAND flash cell array 650 is put off until a page write operation occurs N number of times.

Since the fusion memory system 600 of FIG. 10 does not perform an operation of writing changes in a flash memory whenever the changes occur in meta data, the frequency of meta writing is minimized or reduced. Thus, random write performance of system is improved and the life of the system is improved.

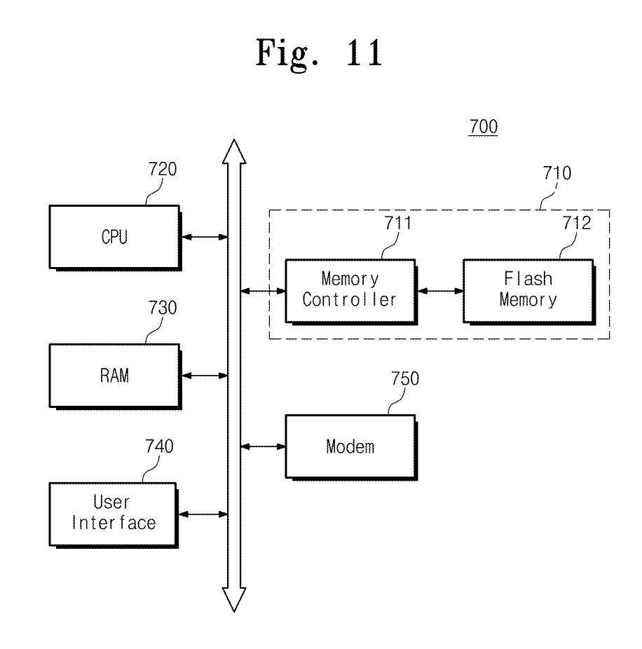

FIG. 11 is a block diagram illustrating another application example of the inventive concept applied to a computational system.

Referring to FIG. 11, a computational system 700 may include a CPU 720, a RAM 730, a user interface 740, a modem 750 such as a baseband chip set and a memory system 710 including a memory controller 711 and a flash memory 712 that are electrically connected to a system bus 760.

The memory system 710 may be constituted to be the same with the structure illustrated in FIG. 9 or FIG. 10.

In the case that the computational system 700 is a mobile device, it may further include a battery for supplying an operation voltage of the computational system 700 autonomously.

In the case of mobile device, for a dual processing operation, the CPU 720 may be built in the mobile device as a dual processor type. In this case, setting the RAM 730 in every processor is avoided. Thus, the RAM 730 may include a dual port and a common memory region so that the RAM 730 is used to be shared by processors. This is done because compact of terminal is one of factors greatly affecting the competitive edge of the product.

The computational system 700 performs a writing of write data and meta data in accordance with some embodiments of the inventive concept in response to a write request from a host.

The meta data changed when the meta data is unloaded is updated through the memory controller 711 and an operation of programming the meta data in the flash memory 712 is put off until a page write operation occurs N number of times.

Since the computational system 700 of FIG. 11 does not perform an operation of writing changes in a flash memory 712 whenever the changes occur in meta data, the frequency of meta writing is minimized or reduced. Thus, random write performance of computational system is improved and the life of the computational system is improved. That is, without writing changed meta data in the flash memory 712 whenever changes occur in the meta data, the computational system 700 restores the changed meta data to the latest meta data using a logical address stored in a page spare area of the data page and writes the changed meta data in the flash memory 712 only when the number of data page writings reaches the number of times set.

Although not illustrated in the drawing, the computational system 700 may further include an application chip set, a camera image processor CIS, a mobile DRAM or the like. The memory system 710 may be embodied by a solid state drive SSD using a nonvolatile memory when storing data. The memory system 710 may be embodied by a fusion flash memory (e.g., one NAND flash memory).

The flash memory and/or the memory controller may be mounted using various types of packages. For example, the flash memory and/or the memory controller may be mounted by various types of packages such as PoP (package on package), ball grid array (BGA), chip scale package (CSP), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline (SOIC), shrink small outline package (SSOP), thin small outline (TSOP), thin quad flatpack (TQFP), system in package (SIP), multi chip package (MCP), wafer-level fabricated package (WFP), wafer-level processed stack package (WSP) and mounted.

According to certain embodiments of the inventive concept, since the frequency of meta data writing is minimized or reduced, the random write performance is improved and the life of semiconductor storage device is improved.

The above-disclosed subject matter is to be considered illustrative, and not restrictive, and the appended claims are intended to cover all such modifications, enhancements, and other embodiments, which fall within the scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A method of writing meta data in a semiconductor storage device including a controller having a buffer, a portion of the buffer serving as a meta memory, and nonvolatile storage medium, the method comprising:
using the controller to determine a maximum number of written meta data pages N, where N is natural number;
receiving write data and corresponding meta data in the controller, storing the write data in the buffer, and loading the meta data in the meta memory;
writing the write data to the storage medium and updating the meta data in the meta memory as updated meta data;
writing the updated meta data to an updated meta data region of the buffer and determining a number of written meta data pages in the updated meta data region; and
only upon determining that the number of written meta data pages exceeds the maximum number of written meta data pages N, performing a meta data write operation writing the updated meta data stored in the updated meta data region to the storage medium.

2. The method of claim 1, wherein the a maximum number of written meta data pages N is determined by comparing a writing time of meta data and a data scanning time of a spare area in a page of the storage medium.

3. The method of claim 2, further comprising:
performing a clean page check operation for the meta data when loaded to the meta memory so long as the number of written meta data pages in the updated meta data region remains less than the maximum number of written meta data pages N.

4. The method of claim 2, further comprising:
performing a clean page check operation for the meta data when loaded to the meta memory when the number of written meta data pages in the updated meta data region equals the maximum number of written meta data pages N.

5. The method of claim 4, wherein the clean page check restores a latest meta data loaded to the meta memory.

6. The method of claim 5, wherein the clean page check comprises:
scanning a page spare area for a data page recorded as a clean page of meta data; and
scanning data page after increasing a page number until an actual clean page is obtained.

7. The method of claim 6, wherein upon scanning the data page after increasing the page number and determining a non-clean page, storing a logical address in the page spare area, and storing a physical address for the scanned page.

8. The method of claim 7, wherein the clean page check is performed upon receiving a page read command or a cache read command.

9. The method of claim 7, wherein when an actual clean page is obtained, write data is written to the actual clean page and the loaded meta data is updated.

10. A method of writing meta data comprising:
setting the number of data page writings depending on a time difference between a read operation of flash memory and a write operation of flash memory, and then without writing changed meta data in a flash memory whenever changes occur in the meta data, the changed meta data is restored to the latest meta data using a logical address stored in a page spare area of the data page and the changed meta data is written in the flash memory only when the number of data page writings reaches the number of time that is set.

11. The method of claim 10, wherein the latest meta data is obtained by scanning a page spare area of data page first recorded in the form of clean page in the meta data and scanning a data page while increasing a page until a real clean page is detected.

12. The method of claim 10, wherein the number of data page writings is set to be reduced in a host read operation mode of the flash memory performed by a host connected to the flash memory.

13. The method of claim 12, wherein the write operation of meta data is performed in a normal operation of the host.

14. The method of claim 11, wherein the scanning operation of the clean page is performed when receiving a page read command.

15. The method of claim 11, wherein the scanning operation of the clean page is performed when receiving a cache read command.

16. The method of claim 11, wherein the host connected to the flash memory is applied to a solid state drive or a memory card.

17. A method executing a first write operation and a second write operation requested by a host to a semiconductor storage device including a controller having a volatile memory and nonvolatile storage medium, the method comprising:
receiving in the controller first write data and first meta data related to the first write operation, and then receiving second write data and second meta data related to the second write operation;
writing the first write data to the storage medium, updating the first meta data in response to writing the first write data to generate updated first meta data, and temporarily storing the updated first meta data in the volatile memory; and thereafter,
writing the second write data to the storage medium, updating the second meta data in response to writing the second write data to generate updated second meta data, and temporarily storing the updated second meta data in the volatile memory; and thereafter,
writing the updated first meta data and the updated second meta data from the volatile memory to the storage medium, only upon determining that a combination of the updated first meta data and updated second meta data stored in the volatile memory exceeds a control value.

18. The method of claim 17, wherein the control value is determined by comparing a writing time for meta data to the storage medium and a data scanning time of a spare area of a page in the storage medium.

19. The method of claim 17, wherein the volatile memory is at least a portion of a Random Access Memory (RAM) buffer disposed in the controller.

20. The method of claim 19, wherein the storage medium comprises flash memory.
